(19) United States
(12) Patent Application Publication
(10) Pub. No.: US 2015/0154732 A1
(43) Pub. Date: Jun. 4, 2015

(54) COMPOSITING OF SURFACE BUFFERS USING PAGE TABLE MANIPULATION

(71) Applicant: NVIDIA CORPORATION, Santa Clara, CA (US)

(72) Inventors: Kirill ARTAMONOV, Espoo (FI); Michael FRYDRYCH, Espoo (FI)

(73) Assignee: NVIDIA CORPORATION, Santa Clara, CA (US)

(21) Appl. No.: 14/094,932

(22) Filed: Dec. 3, 2013

(51) Int. Cl. G06T 1/60

(52) U.S. Cl. CPC G06T 1/60

(57) ABSTRACT

One embodiment of the present invention sets forth a method for compositing surface buffered data for display. The method includes identifying a first set of memory mappings that associates a first set of contiguous virtual addresses with a first set of image data. The method also includes identifying a second set of memory mappings that associates a second set of contiguous virtual addresses with a second set of image data. The method further includes generating a third set of memory mappings based on the first set of memory mappings and the second set of memory mappings that associates a third set of contiguous virtual addresses with both the first set of image data and the second set of image data. Further embodiments provide, among other things, a computing device, a display subsystem, and a non-transitory computer-readable medium configured to carry out method steps set forth above.

### BACKGROUND OF THE INVENTION

1. Field of the Invention

Embodiments of the present invention generally relate to graphics processing and, more specifically, to compositing of surface buffers using page table manipulation.

2. Description of the Related Art

Typically, computer systems perform drawing operations to generate pixel data for display, to provide visual information to a user. These drawing operations store pixel data in memory buffers. Each of the buffers is a contiguous block of memory. A display controller reads the pixel data in the memory buffers, converts the pixel data into a format capable of being interpreted by a display device, such as a computer monitor, and outputs the converted data to the display device for display.

In some instances, an application program, display driver or another entity wishes to provide pixel data to the display controller via multiple memory buffers that are not adjacent to one another. There are several approaches by which computer systems allow the display controller to read from different memory buffers that are not adjacent to one another and thus do not collectively constitute a single contiguous block of memory.

In one approach, a display controller may be equipped with a hardware compositing subsystem. The hardware compositing subsystem receives input from several different memory buffers and composites the input from the different memory buffers for display on the display device. The hardware compositing subsystem therefore allows the display controller to read pixel data from more than one memory buffer. However, one drawback of a hardware compositing subsystem is that the hardware compositing subsystem is only able to read from a limited number of memory buffers. More specifically, because the hardware compositing subsystem is implemented in hardware, a specific number of discrete hardware components are provided for each memory buffer from which the hardware compositing subsystem reads. Thus, the hardware compositing subsystem is generally not capable of performing compositing operations for a number of memory buffers that is greater than this memory buffer limit.

In another approach, the computer system performs software compositing operations. Traditionally, such operations include requests to the parallel processing subsystem, or to other graphics subsystems such as a 2D blit unit to perform software compositing operations for at least two memory buffers. Such software compositing operations “combine” the at least two memory buffers into a single memory buffer that is contiguous in virtual memory address space, thereby reducing the total number of memory buffers for display. One drawback of this software-based approach is that although the software-based approach is useful to permit the display controller to read from a large number of memory buffers, such software compositing operations are costly and consume resources in the graphics subsystems, such as the 2D blit unit or parallel processing subsystem that could be used more effectively for other operations.

As the foregoing illustrates, there is a need in the art for a more effective approach to displaying data that is stored across multiple memory buffers.

### SUMMARY OF THE INVENTION

One embodiment of the present invention sets forth a method for compositing surface buffered data for display. The method includes identifying a first set of memory mappings that associates a first set of contiguous virtual addresses with a first set of image data. The method also includes identifying a second set of memory mappings that associates a second set of contiguous virtual addresses with a second set of image data. The method further includes generating a third set of memory mappings based on the first set of memory mappings and the second set of memory mappings that associates a third set of contiguous virtual addresses with both the first set of image data and the second set of image data.

Further embodiments provide, among other things, a computing device, a display subsystem, and a non-transitory computer-readable medium configured to carry out method steps set forth above.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3A is a conceptual illustration of a display subsystem, according to one embodiment of the present invention;

FIG. 3B is a conceptual illustration of a hardware compositing subsystem that may be implemented with various embodiments of the present invention;

FIG. 3C is a conceptual illustration of how different memory buffers may be made available to a display controller, according to one embodiment of the present invention;

FIG. 4A is a conceptual illustration of a technique for compositing memory buffers, according to one embodiment of the present invention;

FIG. 4B is a conceptual illustration of a technique for compositing memory buffers, according to another embodiment of the present invention;

FIG. 4C is a conceptual illustration of a sequence of operations for packing image data, according to one embodiment of the present invention; and

FIG. 5 is a flow diagram of method steps for performing remapping operations for a display controller, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

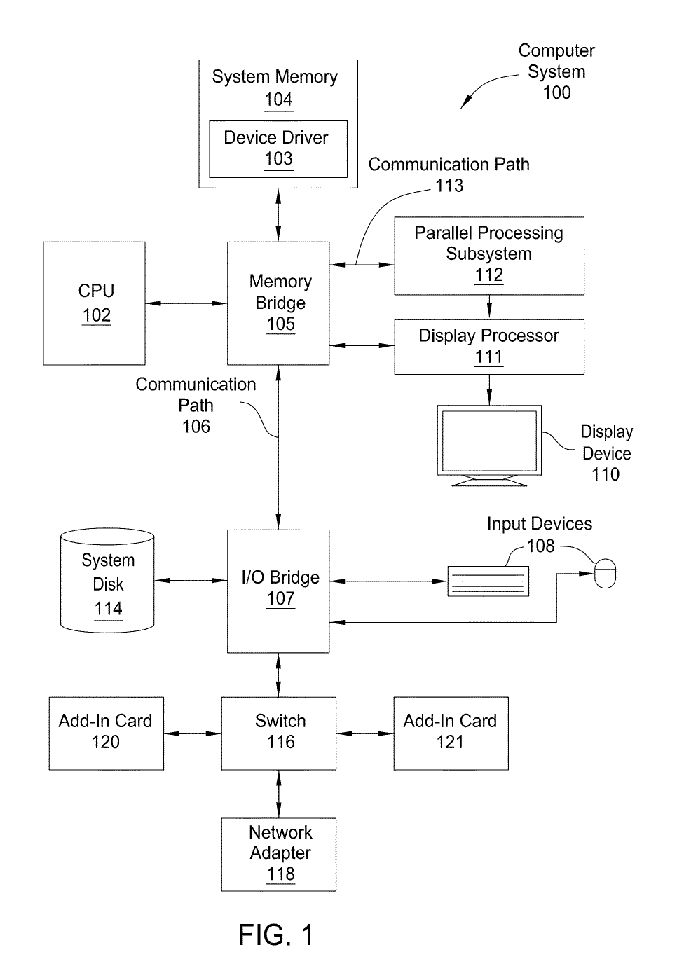

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive information (e.g., user input information) from input devices 108, such as a keyboard, and/or a mouse, and forward the input information to CPU 102 for processing via communication path 106 and memory bridge 105. Display controller 111 receives pixel data from parallel processing subsystem 112 and/or from system memory 104, through memory bridge 105, converts the pixel data to a format capable of being displayed on display device 110, and transmits the converted data to the display device 110 for display. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

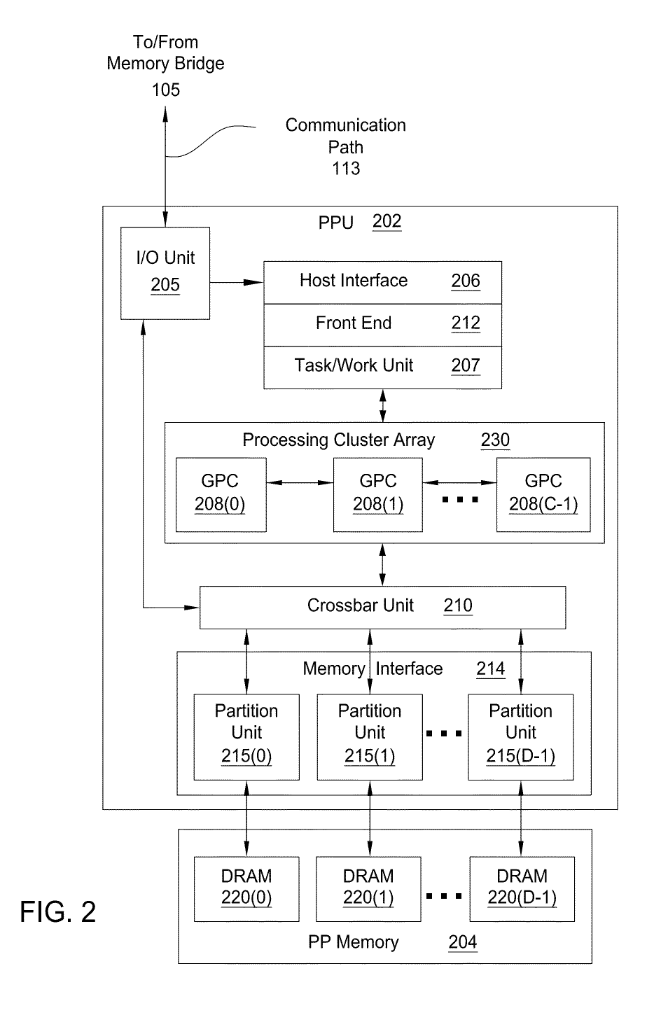

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with the, memory bridge 105, I/O bridge 107, display controller 111, and/or other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202 having a particular architecture, as indicated above, parallel processing subsystem 112 may include any number of PPUs 202 having the same or different architecture. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In operation, front end 212 transmits processing tasks received from host interface 206 to a work distribution unit (not shown) within task/work unit 207.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Compositing of Surface Buffers Using Page Table Manipulation

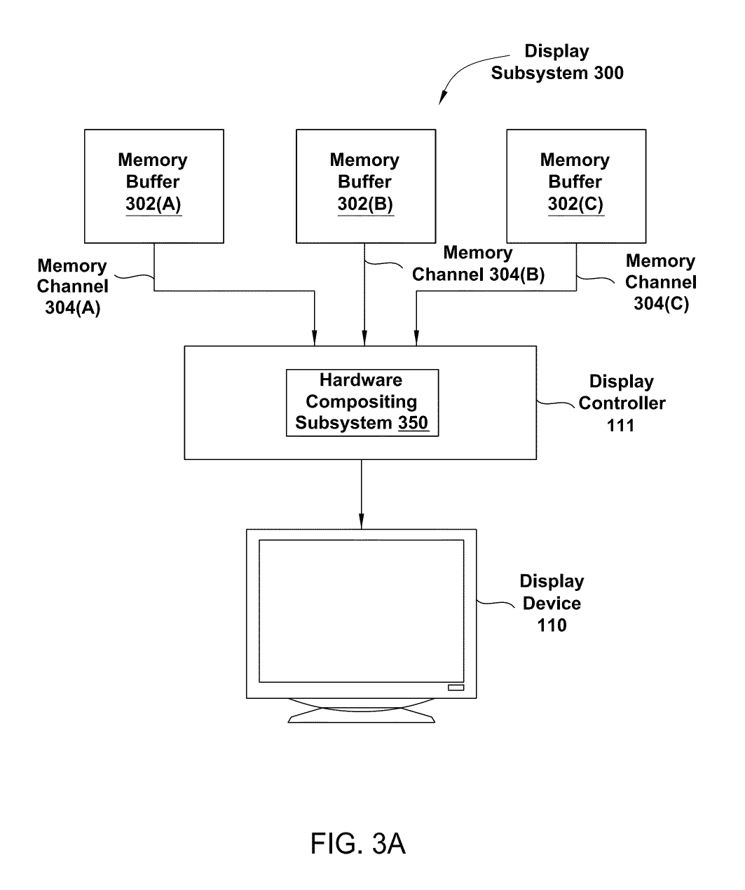

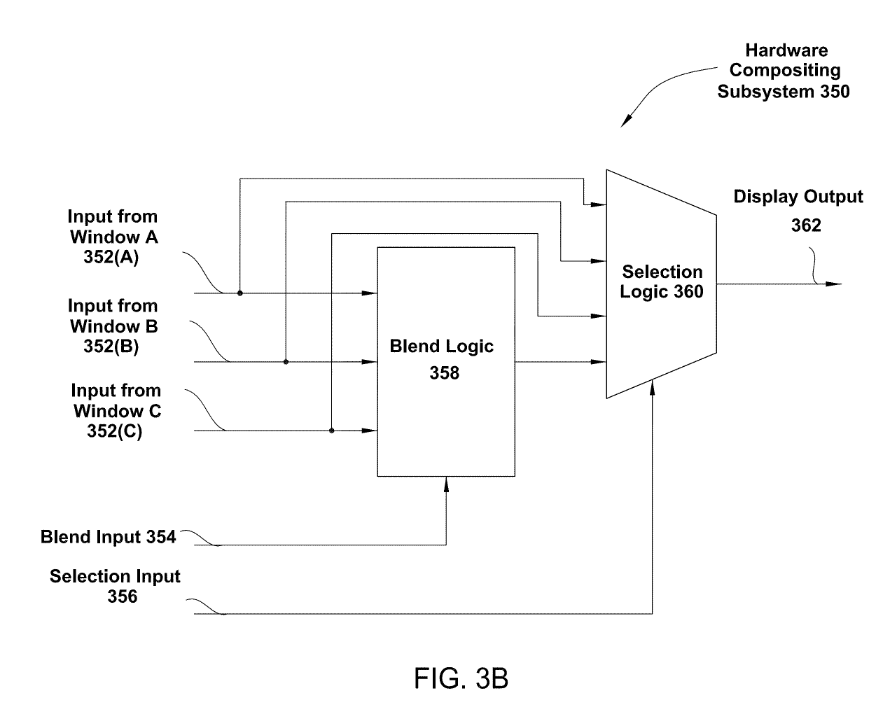

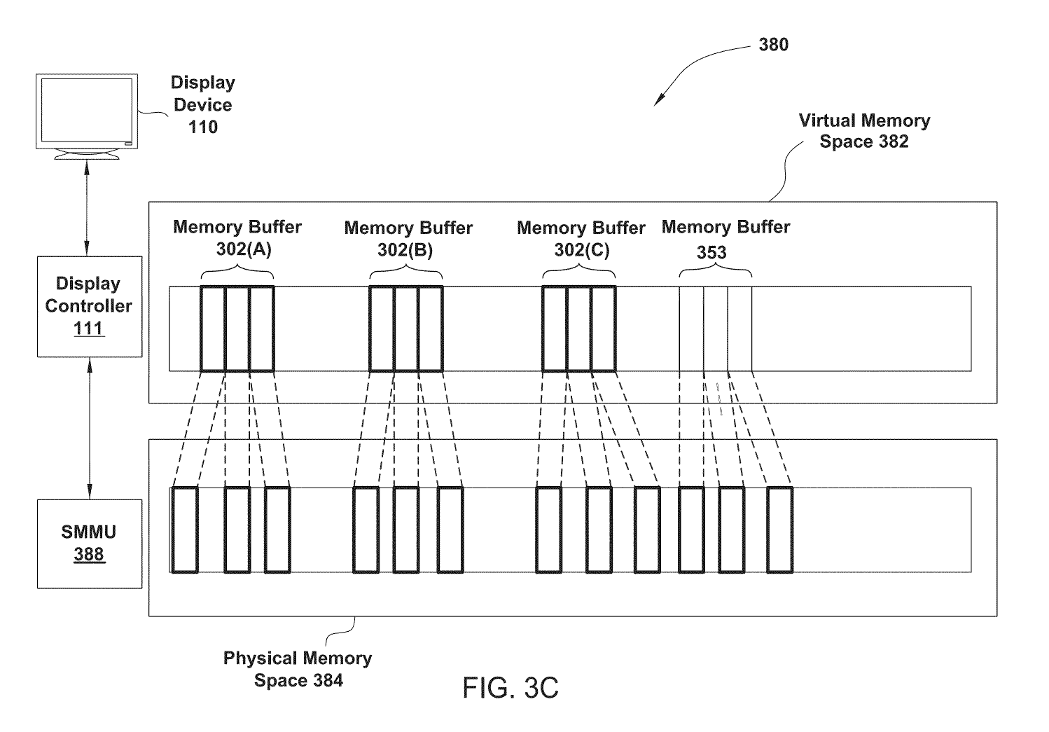

FIG. 3A is a conceptual illustration of a display subsystem 300, according to one embodiment of the present invention. As shown, the display subsystem 300 includes a display controller 111 that accepts data from memory buffers 302, and that is coupled to a display device 110. Although three memory buffers 302 are depicted in FIG. 3A, the inventive concepts set forth herein are not limited to a configuration with only three memory buffers 302.

Referring momentarily to FIG. 2, CPU 102 and parallel processing subsystem 112 perform drawing operations to generate pixel data for display on display device 110. These drawing operations store pixel data in memory buffers 302 located at different memory locations. Referring back to FIG. 3A, display controller 111 reads pixel data from the memory buffers 302, converts the pixel data into a format capable of being interpreted by display device 110, and outputs data to display device 110 for display.

In operation, the CPU 102 and parallel processing subsystem 112 write to several different memory buffers 302. The memory buffers 302 may be located in PP memory 204, in system memory 104, or in other memory as is generally known in the art. The different memory buffers 302 store pixel data corresponding to operations for drawing different screen elements. For example, the CPU 102 and/or parallel processing subsystem 112 may write to a first memory buffer 302(A) for display of soft buttons, to a second memory buffer for display of other user interface elements, to a third memory buffer for a status bar, and to a fourth memory buffer for a background image. Because the drawing operations that write to the different memory buffers 302 are generally performed at different times, and by different software elements, the different memory buffers 302 may be located at different locations in virtual memory space.

Although the individual memory buffers 302 may be located at different locations in virtual memory space, each individual memory buffer 302 is allocated as a contiguous block of virtual memory. The memory buffers 302 are contiguous in virtual memory so that the display controller 111 is able to read the data in the memory buffers 302. To read the data in the memory buffers 302, device driver 103 or another unit provides display controller 111 with a starting virtual address for a particular memory buffer 302 and an end condition. The display controller 111 reads a memory buffer 302 by traversing the memory buffer 302 in a contiguous manner from the starting virtual address until the end condition occurs.

In some instances, an application program, display driver 103, or another entity wishes to provide multiple memory buffers 302 to display controller 111 for display. However, because the display controller 111 reads data from contiguous blocks of memory, certain features are implemented to allow the display controller 111 to read from different memory buffers 302 that may not be adjacent to one another in virtual memory space.

One feature that allows display controller 111 to read from a number of different memory buffers 302 is hardware compositing subsystem 350 included in display controller 111. Hardware compositing subsystem 350 receives input from several different memory buffers 302 that are not adjacent to each other in virtual memory space, through several different memory channels 304 and composites the input from the different memory buffers 302 for display on the display device 110.

FIG. 3B is a conceptual illustration of a hardware compositing subsystem 350 that may be implemented with various embodiments of the present invention. As shown, the hardware compositing subsystem 350 receives inputs 352 from memory buffers 302, blend input 354, and selection input 356 and outputs display output 362. Further, as shown, the hardware compositing subsystem 350 includes blend logic 358 and selection logic 360 for performing hardware compositing functionality.

Blend subsystem 350 receives input including input pixel data 352 from three different memory buffers 302. Blend logic 358 receives the inputs 352 and applies blending operations to the inputs 352 based on a blend input 354. The blend input 354 specifies blend characteristics, such as the weight to be given to the inputs 352, as well as other characteristics, as are generally known in the art. The blend input 354 may be based on alpha values and on whether the pixels corresponding to the different memory buffers 352 overlap in the screen. Selection logic 360 receives selection input 356, and selects output from blend logic 358 or unblended inputs 352. The selection logic 360 is based on whether pixels from different memory buffers 352 overlap in the screen. If pixels overlap, then selection input 356 selects output from blend logic 358. If pixels do not overlap, then only one memory buffer 302 has data for that pixel, and the selection input 356 chooses that data. Although shown and described as reading from three different memory buffers 302, in various embodiments, the display controller 111 may have more or fewer discrete hardware components and therefore may be capable of reading from more or fewer memory buffers 302.

Because the hardware compositing subsystem 350 is implemented in hardware, a specific number of discrete hardware components are provided for each memory buffer 302 from which the hardware compositing subsystem 350 reads. Thus, the hardware compositing subsystem 350 is capable of performing compositing operations for a specific and limited number of memory buffers 302, and is generally not capable of performing such compositing operations for a number of memory buffers that is greater than this memory buffer limit.

FIG. 3C is a conceptual illustration 380 of how different memory buffers may be made available to a display controller 111, according to one embodiment of the present invention. As stated above, the display controller 111 accesses the memory buffers 302 with virtual memory addresses. In virtual memory space 382, the data for each of the memory buffers 302 is contiguous. That is, the data for any particular memory buffer 302 begins at a particular virtual memory address and occupies virtual memory contiguously to an end point. This contiguousness allows the display controller 111 to quickly read through the data of the memory buffer 352. Because of the limitations discussed above with respect to FIG. 3B, the display controller 111 is not able to read a fourth, additional memory buffer 353 for display.

If software, such as device driver 103, wishes to display data from more than the memory buffer limit number of memory buffers 302, then software performs additional operations so that all the data that is to be displayed is located within the specified number or fewer memory buffers 302. Traditionally, such operations include requests to the parallel processing subsystem 112, or to other graphics subsystems such as a 2D blitting unit (not shown) to perform software compositing operations for at least two memory buffers 302. Such software compositing operations “combine” the at least two memory buffers 302 into a single memory buffer that is contiguous in virtual memory address space 382, thereby reducing the total number of memory buffers 302 for display. Although useful to permit the display controller 111 to display pixel data originally contained in a large number of memory buffers 302, such software compositing operations are costly and consume resources in the graphics subsystems, such as the 2D blitting unit or parallel processing subsystem 112 that could be used for other operations.

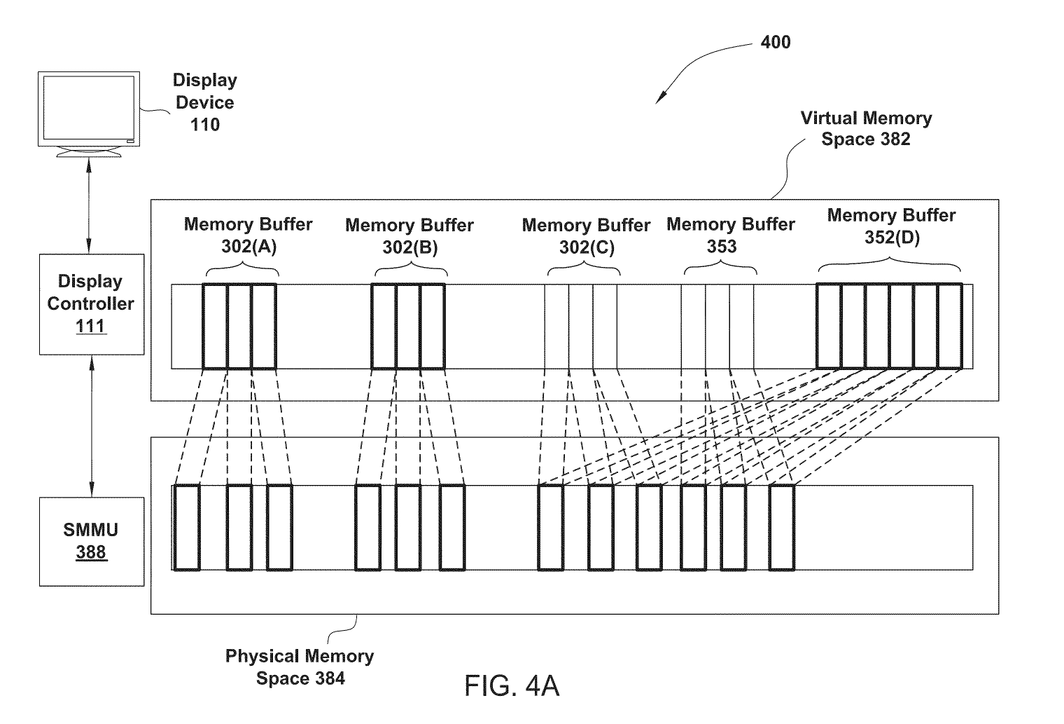

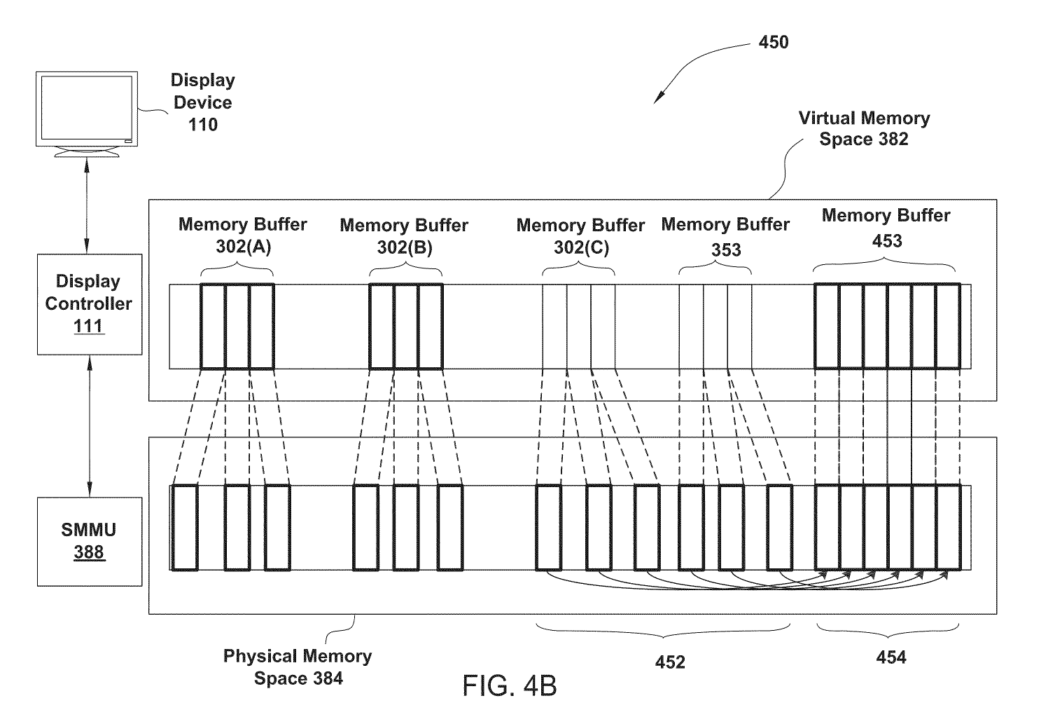

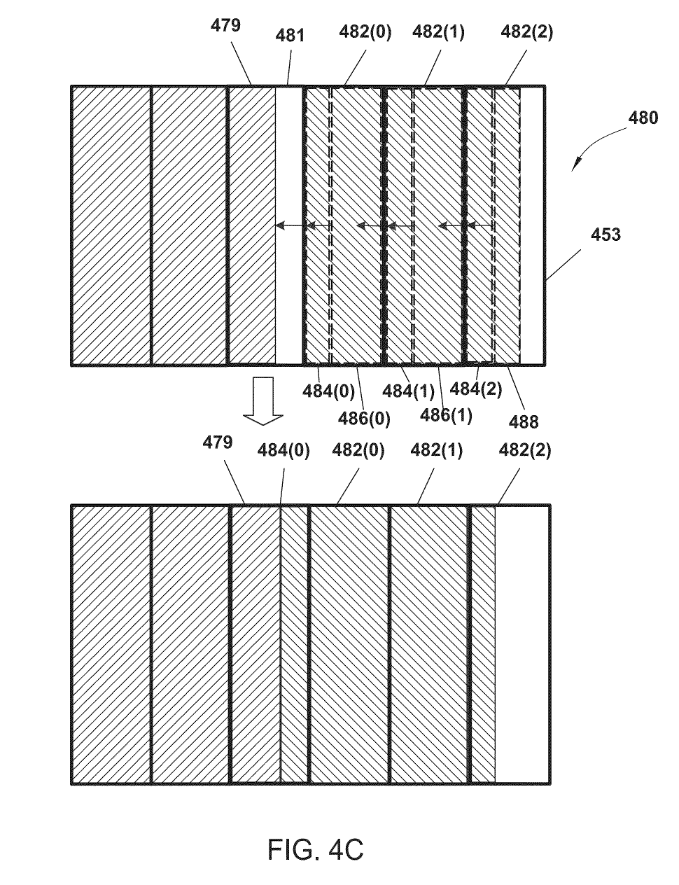

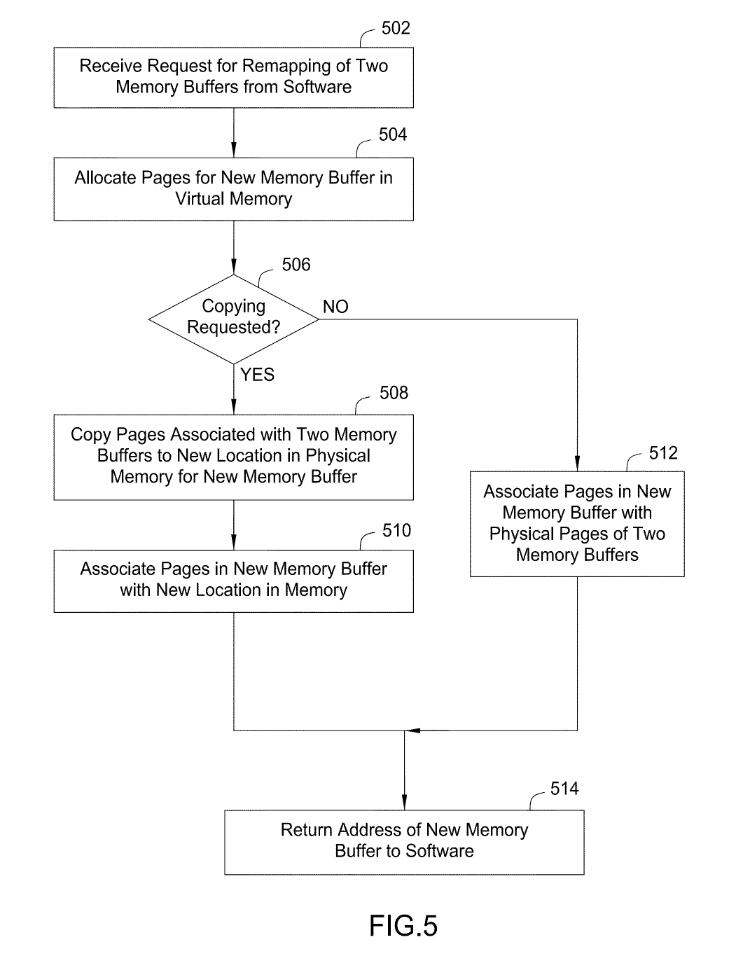

In some instances, such as when one memory buffers stores pixel data that does not overlap with pixel data for another memory buffer, software compositing does not require complex blending operations or other complex calculations. Instead, software compositing only includes choosing one of several memory buffers from which to read pixel data, based on which memory buffer includes pixel data for a particular screen pixel. Such functions can be performed by a system memory management unit (SMMU) 388, instead of the CPU 102, parallel processing subsystem 112, or 2D blitter as described above. Performing such functions in the SMMU 388 reduces the processing burden on those other hardware units in situations where more than the memory buffer limit number of memory buffers 302 are available for the display controller 111 and at least two such memory buffers 302 do not overlap or overlap only to a small degree. FIGS. 4A-5 present techniques for compositing memory buffers that do not overlap.

FIG. 4A is a conceptual illustration of a technique 400 for compositing memory buffers, according to one embodiment of the present invention. To allow the display controller 111 to read from a number of memory buffers that is greater than the memory buffer limit, a system memory management unit (SMMU) 388 performs remapping operations to remap virtual addresses for various memory buffers 302 so that display controller 111 may read the various memory buffers 302. A discussion of the general operation of SMMU 388 is now provided, to provide context for a subsequent discussion of the remapping operations.

In operation, when the display controller 111 wishes to read pixel data from a particular memory buffer 352, the display controller 111 provides memory access requests specifying virtual memory addresses to SMMU 388. SMMU 388 translates the virtual memory addresses to physical memory addresses. Data from memory buffers 302 are then read based on the physical memory addresses and provided to the display controller 111. Accessing data with virtual memory addresses in this manner allows the display controller 111 to view the data as being contiguous even though the data may not be contiguous in physical memory. SMMU 388 translates virtual memory addresses to physical memory addresses with a page table. More specifically, the SMMU 388 maintains a page table that includes page table entries. The page table entries associate pages in the virtual memory space 382 (shown as vertical rectangles) with pages in the physical memory space 384 (also shown as vertical rectangles). When the display controller 111 requests data at a particular virtual memory address, the SMMU 388 references the page table to translate a portion of the virtual memory address that references the virtual memory page into a memory address that references a physical page in physical memory in order to determine a full physical memory address.

As described above, the SMMU 388 performs remapping operations so that pixel data that is originally stored in more than a maximum number of memory buffers 302 is remapped to less than or equal to the maximum number of memory buffers 302. To perform remapping operations, software, such as device driver 103 requests SMMU 388 to perform such remapping operations, specifying the memory buffers 302 to be remapped. In response, the SMMU 388 allocates a new set of addresses in virtual memory space 382 that are contiguous. More specifically, SMMU 388 allocates a consecutive series of pages in virtual memory space 382, where the series is large enough to store all of the data included in the memory buffers 302 to be remapped. Once allocated, the SMMU 388 associates the addresses of the newly allocated pages in the virtual memory space 382 with the addresses of the pages in the physical memory space 384 that are associated with the memory buffers 302 specified to be remapped.

In the example depicted in FIG. 4A, device driver 103 requests SMMU 388 to remap memory buffer 352(C) and memory buffer 353. In response, SMMU 388 allocates a consecutive series of pages (each page is depicted as a vertical rectangle in FIG. 4A), which are included in memory buffer 352(D). The SMMU 388 allocates a sufficient number of pages for the image data referred to by memory buffer 352(C) and memory buffer 353. Subsequently, SMMU 388 maps the pages included in memory buffer 352(D) to the physical pages associated with memory buffer 352(C) and memory buffer 353, in the page table maintained by SMMU 388.

After completing the remapping operation, SMMU 388 specifies to software, such as device driver 103, the virtual address of the newly mapped memory buffer 352(D). Software subsequently informs display controller 111 of the newly remapped buffer 352(D) so that display controller 111 may read image data from the newly remapped buffer 352(D). Display controller 111 reads pixel data from this newly mapped memory buffer 352(D) for output to display device 110.

The remapping operation 400 converts a larger number of contiguous memory buffers 302 into a smaller number of contiguous memory buffers 302. In FIG. 4A, prior to the remapping operation 400, there were four contiguous memory buffers. After the remapping operation 400, there are three contiguous memory buffers.

FIG. 4B is a conceptual illustration of a technique 450 for compositing memory buffers 302, according to another embodiment of the present invention. In some instances, software, such as the device driver 103, may wish to alter the data for the remapped memory buffer without altering the data in the original memory buffers. In such instances, as part of the remapping operation, the SMMU 388 or software such as the device driver 103 requests a unit that has data copying capabilities (a “copy-capable unit”), such as the CPU 102, to copy data from pages for the memory buffers for which remapping is requested to new physical pages. Subsequently, the SMMU 388 associates the pages in the newly created virtual memory buffer 453 with the newly copied pages 454 in physical memory. This copied data may then be altered by software such as the device driver 103 without affecting the original data 452.

In the example depicted in FIG. 4B, SMMU 388 receives a request to composite memory buffer 352(C) and memory buffer 353. In response, SMMU 388 allocates contiguous pages for memory buffer 453. Subsequently, the copy-capable unit receives requests for data in physical pages 452, which are associated with memory buffer 352(C) and memory buffer 353, to be copied to new pages 454 in physical memory space 384. After copying, the SMMU 388 associates the newly allocated pages 453 in virtual memory space 382 with the newly copied data 454 in physical memory space.

FIG. 4C is a conceptual illustration of a sequence of operations 480 for packing image data, according to one embodiment of the present invention. As described above, the display controller 111 generally reads pixel data from memory buffers 352 in a contiguous manner until a stop condition is met. Pixel data in the memory buffer 302 may not occupy the memory pages associated with the memory buffer 302 entirely, forming “gaps” in a memory page. “Gaps” in pixel data may be generated due to the remapping operation described above with respect to FIG. 4B. More specifically, the new memory buffer 453 includes pixel data from memory buffer 352(C) and memory buffer 353. Because the pages from the two memory buffers are simply appended together, a gap 481 exists between the data from the first memory buffer 352(C) and the data from the second memory buffer 353. The gap 481 exists because the data from memory buffer 352(C) does not extend to the end of the last page in memory buffer 352(C). If “gaps” exist in the data, then the display controller 111 reads those gaps and interprets the data stored therein as pixel data. However, in some situations, the data from memory buffer 352(C) may extend to the end of the last page in memory buffer 352(C). In such situations, the packing operations described herein are not necessary because no gap exists.

In order to remove this gap 481, the device driver 103 or other software copies the data from the second memory buffer 382(B), now stored in pages 454, such that the gap 481 is occupied by data from the second memory buffer 382(B). More specifically, the device driver 103 or other software copies a first portion of data 484(0) from a first page 482(0) that fits into gap 481 from the first page 482(0) of the pages from memory buffer 353 to the final page 479 from first memory buffer 302(C), in order to fill the gap 481. The device driver 103 also copies a second portion 486(0) of the first page 482(0) to align with the beginning of the first page 482(0) and copies a first portion 484(1) from a second page 482(1) into the first page 482(0). The device driver 103 copies the different portions 484, portions 486, and final portion 488 downward in this manner until the packing operation is complete and no gap exists between data from the second memory buffer 382(B) and data from memory buffer 353.

FIG. 5 is a flow diagram of method steps for performing remapping operations for a display controller 111, according to one embodiment of the present invention. Although the method steps are described in conjunction with FIG. 1-4C, persons skilled in the art will understand that any system configured to perform the method steps, in any order, falls within the scope of the present invention.

As shown, a method 500 begins in step 502, in which SMMU 388 receives a request for remapping of two memory buffers from software, such as device driver 103. In step 504, the SMMU 388 allocates pages for a new memory buffer in virtual memory. The SMMU 388 allocates enough pages to hold all of the data from the two memory buffers for which remapping is requested. In step 506, the SMMU 388 determines whether copying of data to a new physical memory location is requested. Software, such as device driver 103, may request such copying. If the SMMU 388 determines that copying of data is requested, then the method proceeds to step 508.

In step 508, the SMMU 388 (or another unit such as device driver 103 or other software) requests that data be copied to a new physical location. In step 510, the SMMU 388 associates the virtual memory pages with the memory pages into which the data is copied in step 508, in the page table. After step 510, the method 500 proceeds to step 514. If the SMMU 388 determines that copying of data is not required, then the method proceeds to step 512. In step 512, the SMMU 388 associates pages in the new memory buffer with physical pages of the two memory buffers, in the page table. After step 512, the method proceeds to step 514. In step 514, the SMMU 388 returns the address of the new memory buffer to software.

In sum, an SMMU composites image data through page table manipulation for processing by a display controller. The SMMU receives a request for remapping memory buffers. In response, the SMMU allocates a new set of virtual memory pages and associates the new set of virtual memory pages with the data stored in the memory buffers for which remapping is requested. If a requestor desires for the data associated with the original memory buffers to not be altered, then the requestor may request that data be copied to a new set of physical pages. A CPU or other unit with copying capabilities performs the requested copying operations. The SMMU associates the newly allocated set of virtual memory pages with the physical pages that store the newly copied data. If a gap exists in the newly copied data, the CPU or other unit with copying capabilities performs additional copying operations to pack the data within the new physical pages.

One advantage of the techniques described herein is that a number of memory buffers that is greater than a memory buffer limit are provided to a display controller for processing and output to a display device. By allowing such a flexible number of memory buffers to be displayed, the techniques provide software, such as a device driver and/or application programs, with flexibility to render to a large number of memory buffers. Another advantage of the techniques described herein is that compositing operations are performed by an SMMU. By performing compositing operations with an SMMU, other units, such as a CPU or parallel processing unit are freed of the processing workload typically associated with such compositing operations.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A method for compositing surface buffered data for display, the method comprising:
identifying a first set of memory mappings that associates a first set of contiguous virtual addresses with a first set of image data;
identifying a second set of memory mappings that associates a second set of contiguous virtual addresses with a second set of image data;
generating a third set of memory mappings based on the first set of memory mappings and the second set of memory mappings that associates a third set of contiguous virtual addresses with both the first set of image data and the second set of image data.

2. The method of claim 1, wherein the first set of contiguous virtual addresses corresponds to a first set of contiguous virtual pages, the second set of contiguous virtual addresses corresponds to a second set of contiguous virtual pages, the first set of image data is stored in a first set of physical pages, and the second set of image data is stored in a second set of physical pages.

3. The method of claim 2, wherein generating the third set of mappings comprises associating a third set of contiguous virtual pages with both the first set of physical pages and the second set of physical pages.

4. The method of claim 2, wherein generating the third set of mappings comprises copying the first set of image data and the second set of image data to a third set of physical pages and associating a third set of contiguous virtual pages with the third set of physical pages.

5. The method of claim 4, further comprising packing the first set of image data and the second set of image data within the third set of physical pages to remove a gap between the first set of image data and the second set of image data.

6. The method of claim 5, wherein packing the first set of image data comprises moving the second set of image data within the third set of physical pages to occupy the gap between the first set of image data and the second set of image data.

7. The method of claim 1, further comprising:
identifying multiple sets of image data for hardware compositing that include the first set of image data and the second set of image data;
determining that a number of sets of image data included in the multiple sets exceeds a maximum number for hardware compositing; and
generating the third set of memory mappings in response to determining that the number of sets of image data included in the multiple sets exceeds the maximum number.

8. The method of claim 7, further comprising performing a hardware compositing operation on the multiple sets of image data after generating the third set of memory mappings.

9. The method of claim 1, further comprising determining that the first set of image data and the second set of image data do not overlap in screen-space.

10. A display subsystem for compositing surface buffered data for display, the display subsystem comprising:
a system memory management unit (SMMU) configured to:
identify a first set of memory mappings that associates a first set of contiguous virtual addresses with a first set of image data;
identify a second set of memory mappings that associates a second set of contiguous virtual addresses with a second set of image data;
generate a third set of memory mappings based on the first set of memory mappings and the second set of memory mappings that associates a third set of contiguous virtual addresses with both the first set of image data and the second set of image data.

11. The display subsystem of claim 10, wherein the first set of contiguous virtual addresses corresponds to a first set of contiguous virtual pages, the second set of contiguous virtual addresses corresponds to a second set of contiguous virtual pages, the first set of image data is stored in a first set of physical pages, and the second set of image data is stored in a second set of physical pages.

12. The display subsystem of claim 10, wherein generating the third set of mappings comprises associating a third set of contiguous virtual pages with both the first set of physical pages and the second set of physical pages.

13. The display subsystem of claim 10, further comprising a copy-capable unit configured to copy the first set of image data and the second set of image data to a third set of physical pages, wherein the SMMU is further configured to associate a third set of contiguous virtual pages with the third set of physical pages.

14. The display subsystem of claim 13, wherein the copy-capable unit is further configured to pack the first set of image data and the second set of image data within the third set of physical pages to remove a gap between the first set of image data and the second set of image data.

15. The display subsystem of claim 14, wherein packing the first set of image data comprises moving the second set of image data within the third set of physical pages to occupy the gap between the first set of image data and the second set of image data.

16. The display subsystem of claim 10, further comprising:
a device driver configured to:
identify multiple sets of image data for hardware compositing that include the first set of image data and the second set of image data;
determine that a number of sets of image data included in the multiple sets exceeds a maximum number for hardware compositing; and
cause the SMMU to generate the third set of memory mappings in response to determining that the number of sets of image data included in the multiple sets exceeds the maximum number.

17. The display subsystem of claim 16, further comprising a display controller configured to perform a hardware compositing operation on the multiple sets of image data after the SMMU generates the third set of memory mappings.

18. The display subsystem of claim 10, wherein the device driver is further configured to determine that the first set of image data and the second set of image data do not overlap in screen-space.

19. A computing device for compositing surface buffered data for display, the computing device comprising:
a display subsystem comprising:
a system memory management unit (SMMU) configured to:
identify a first set of memory mappings that associates a first set of contiguous virtual addresses with a first set of image data;
identify a second set of memory mappings that associates a second set of contiguous virtual addresses with a second set of image data;
generate a third set of memory mappings based on the first set of memory mappings and the second set of memory mappings that associates a third set of contiguous virtual addresses with both the first set of image data and the second set of image data.

20. The computing device of claim 19, wherein the first set of contiguous virtual addresses corresponds to a first set of contiguous virtual pages, the second set of contiguous virtual addresses corresponds to a second set of contiguous virtual pages, the first set of image data is stored in a first set of physical pages, and the second set of image data is stored in a second set of physical pages.
